(19) United States
(12) Patent Application Publication
(10) Pub. No.: US 2018/0322496 A1
(43) Pub. Date: Nov. 8, 2018

(54) System and Method for Automated Switching of Payment Devices in a Payment Transaction

(71) Applicant: MASTERCARD INTERNATIONAL INCORPORATED, Purchase, NY (US)

(72) Inventors: Ravi Pareek, Pune (IN); Arunmurthy Gurunathan, Pune (IN); Ganesh Shinde, Pune (IN)

(21) Appl. No.: 15/969,131

(22) Filed: May 2, 2018

(30) Foreign Application Priority Data
May 3, 2017 (SG) 10201703614T

(51) Int. Cl. G06Q 20/40; G06Q 20/30

(52) U.S. Cl. CPC G06Q 20/4012; G06Q 20/30

(57) ABSTRACT

A system and method for automated switching of payment devices in a financial transaction are provided. The method comprises, in response to a payment status message from an issuer of a primary payment device which is indicative of a partial approval or a decline of a payment transaction request for the primary payment device, retrieving, from a database, identification data for a secondary payment device which is associated with the primary payment device; generating a secondary payment instruction comprising the identification data of the secondary payment device and an amount or a remaining amount of the payment transaction; and transmitting the payment instruction to an issuer of the secondary payment device.

### CROSS-REFERENCE TO RELATED APPLICATION

This application claims the benefit of and priority to Singapore Patent Application No. 10201703614T filed May 3, 2017. The entire disclosure of the above application is incorporated herein by reference.

### FIELD

The present disclosure generally relates to a system for automated switching of payment devices in a payment transaction, and a method performed by that system.

### BACKGROUND

This section provides background information related to the present disclosure which is not necessarily prior art.

Payment cards, such as credit cards, debit cards and prepaid cards, are often used in financial transactions for the purchase of a product or service. Such financial transactions can either be carried out online or in a physical store. A payment request to purchase a product or service can be carried out on a point-of-sale (POS) device at the merchant's physical store.

Consumers usually own one or more payment cards, which can be issued by different issuers or the same issuer. A consumer may have a preference for using specific payment cards for certain financial transactions. However, each of the payment cards is usually linked to only one payment account, and it is often necessary for consumers to present the specific payment card at the time of the transaction. During a financial transaction, the payment request may be declined due to insufficient funds in a payment card and the consumer is unaware that the payment card has insufficient funds. This leads to a situation which does not benefit both the merchant and the consumer, i.e., the consumer is unable to purchase the product/service and the merchant loses the opportunity to sell his product/service.

Subsequently, the consumer may wish to use a secondary payment card when the payment request for the first payment card is declined. However, this poses an inconvenience to the consumers who may not be able to present the desired secondary payment card at the point of transaction.

There may also be situations when the first payment card has sufficient balance for a partial payment of the financial transaction and the consumer may wish to use the secondary payment card to pay the remaining amount of the financial transaction. However, the payment request may be declined as there is no provision for partial payment of the product/service using two different cards.

A need therefore exists to provide a method and system for automated switching of cards that seeks to address one or more of the above problems.

### SUMMARY

This section provides a general summary of the disclosure, and is not a comprehensive disclosure of its full scope or all of its features. Aspects and embodiments of the disclosure are set out in the accompanying claims.

According to a first aspect of the present disclosure, there is provided a system for automated switching of payment devices during a payment transaction, comprising a facilitator module, the facilitator module comprising: at least one processor; and at least one memory including computer program code; the at least one memory and the computer program code configured to, with the at least one processor, cause the facilitator module at least to: (i) in response to a payment status message from an issuer of a primary payment device which is indicative of a partial approval or a decline of a payment transaction request for the primary payment device, retrieve, from a database, identification data for a secondary payment device which is associated with the primary payment device; (ii) generate a secondary payment instruction comprising the identification data of the secondary payment device, and an amount or a remaining amount of the payment transaction; and (iii) transmit the secondary payment instruction to an issuer of the secondary payment device.

In an embodiment, the payment status message may comprise data which is indicative of insufficient funds in the primary payment device.

In an embodiment, the issuer of the primary payment device may be the same as the issuer of the secondary payment device.

In an embodiment, the facilitator module may be further caused to transmit the payment transaction request to the issuer of the secondary payment device for payment of the remaining amount of the payment transaction.

In an embodiment, the facilitator module may be further caused to receive a registration request for a registration of the secondary payment device; transmit authentication data for authenticating the registration of the secondary payment device; receive an approval status for approving the registration request based on the authentication data; and save identification data in the database upon the successful approval of the registration request.

In an embodiment, the facilitator module may be further caused to: receive a payment status from the issuer of the secondary payment device confirming payment for the payment transaction by the secondary payment device; transmit confirmation data to a merchant associated with the payment transaction request, the confirmation data comprising payment confirmation for the payment transaction; and transmit confirmation data to a user to indicate the successful payment of the payment transaction by the secondary payment device.

In an embodiment, the facilitator module may be further caused to: receive confirmation of an invalid Personal Identification Number (PIN) of the primary payment device; transmit, from the issuer, information confirming the invalidity of the primary payment device PIN; retrieve, from the database, identification data for payment using the secondary payment device; transmit, to the user, a request for a Personal Identification Number (PIN) associated with the secondary payment device; and transmit the payment transaction request to the issuer of the secondary payment device based on a successful verification of the PIN associated with the secondary payment device.

According to a second aspect of the present disclosure, there is provided a method for automated switching of payment devices during a payment transaction, the method comprising: in response to a payment status message from an issuer of a primary payment device which is indicative of a partial approval or a decline of a payment transaction request for the primary payment device, retrieving, from a database, identification data for a secondary payment device which is associated with the primary payment device; generating a secondary payment instruction comprising the identification data of the secondary payment device and an amount or a remaining amount of the payment transaction; and transmitting the payment instruction to an issuer of the secondary payment device.

In an embodiment, the method may further comprise a one-time registration of the secondary payment device before receiving the payment transaction request.

In an embodiment, the one-time registration of the secondary payment device may comprise the steps of: receiving a registration request for a registration of the secondary payment device; transmitting authentication data for authenticating the registration of the secondary payment device; receiving an approval status for approving the registration request based on the authentication data; and saving identification data in the database upon the successful approval of the registration request.

In an embodiment, the method may further comprise the steps of: receiving a payment status from the issuer of the secondary payment device confirming payment for the payment transaction by the secondary payment device; transmitting confirmation data to a merchant associated with the payment transaction request, the confirmation data comprising payment confirmation for the payment transaction.

In an embodiment, the confirmation data is transmitted to the merchant on the condition that the payment status comprises a successful payment of the payment transaction by the secondary payment device.

In an embodiment, the method may further comprise transmitting confirmation data to a user to indicate the successful payment of the payment transaction by the secondary payment device.

In an embodiment, the method may further comprise a partial approval of the payment transaction request by the issuer of the primary payment device.

In an embodiment, the partial approval of the payment request may further comprise the steps of: approving, by the issuer of the primary payment device, a partial payment of the payment transaction; receiving, from the issuer of the primary payment device, a payment status message indicative of the partial approval of the payment transaction request; retrieving, from a database, identification data for payment of the remaining amount using the secondary payment device; and receiving a payment status from the issuer of the secondary payment device indicating a successful payment of the remaining amount of the payment transaction.

In an embodiment, the decline of the payment transaction request for the primary payment device may comprise receiving confirmation of an invalid Personal Identification Number (PIN) of the primary payment device.

In an embodiment, receiving confirmation of the invalid PIN of the primary payment device comprises the steps of: transmitting, from the issuer, information confirming the invalidity of the primary payment device PIN; retrieving, from the database, identification data for payment using the secondary payment device; transmitting, to the user, a request for a Personal Identification Number (PIN) associated with the secondary payment device; and transmitting the payment transaction request to the issuer of the secondary payment device based on a successful verification of the PIN associated with the secondary payment device.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments will be better understood and readily apparent to one of ordinary skill in the art from the following written description, by way of example only, and in conjunction with the drawings, in which:

FIG. 1 shows a flow chart illustrating a method for automated switching of payment devices in a payment transaction, according to an example embodiment.

FIG. 2A shows a schematic diagram illustrating the flow of information in a system for automated switching of payment devices with an identical issuer in the payment transaction, according to an example embodiment.

FIG. 2B shows a schematic diagram illustrating the flow of information in a system for automated switching of payment devices with two different issuers in the payment transaction, according to an example embodiment.

FIG. 3 shows a flow chart illustrating a method for a one-time registration of a secondary payment device according to an example embodiment.

FIG. 4 shows a schematic diagram illustrating the flow of information in a system for the one-time registration of the secondary payment device, according to an example embodiment.

FIG. 5 shows a flow chart illustrating a method for a partial approval of a payment transaction request according to an example embodiment.

FIG. 6 shows a schematic diagram illustrating the flow of information in a system for the partial approval of the payment transaction request, according to an example embodiment.

FIG. 7 shows a flow chart illustrating a method for approval of a payment transaction request for an invalid Personal Identification Number (PIN) of a primary payment device according to an example embodiment.

FIG. 8 shows a schematic diagram of a computer device/system suitable for realizing a facilitator module, according to an example embodiment.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “transmitting”, “retrieving”, “receiving”, “saving”, “outputting”, “identifying”, “authorizing”, “verifying” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the method.

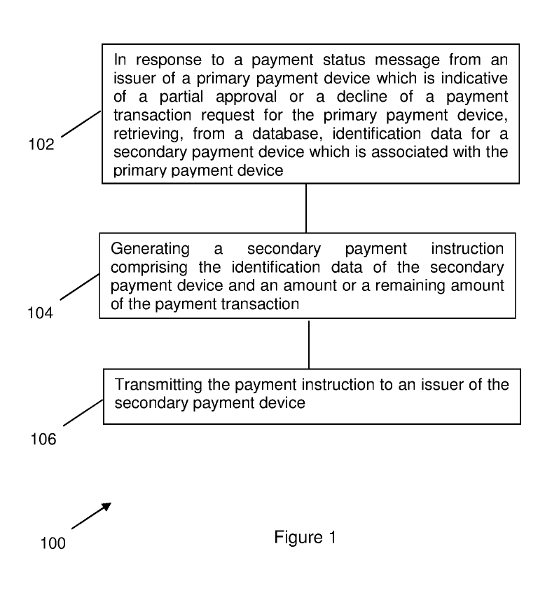

FIG. 1 shows a flow chart 100 illustrating a method for automated switching of payment devices in a payment transaction according to an example embodiment. At step 102, identification data for a secondary payment device, which is associated with a primary payment device, is retrieved from a database. The identification data may be retrieved in response to a payment status message from an issuer of the primary payment device which is indicative of a partial approval or a decline of a payment transaction request for the primary payment device. At step 104, a secondary payment instruction comprising the identification data of the secondary payment device and an amount or a remaining amount of the payment transaction is generated. At step 106, the payment instruction is transmitted to an issuer of the secondary payment device.

In the following description, the term “module” (e.g., acquirer module, facilitator module, issuer module, etc.) can refer to software, a hardware element, or a combination of both. The use of the term ‘module’ may also mean a single computing device or at least a computer network of interconnected computing devices which operate together to perform a particular function. In other words, the module may be contained within a single hardware unit or be distributed among several or many different hardware units.

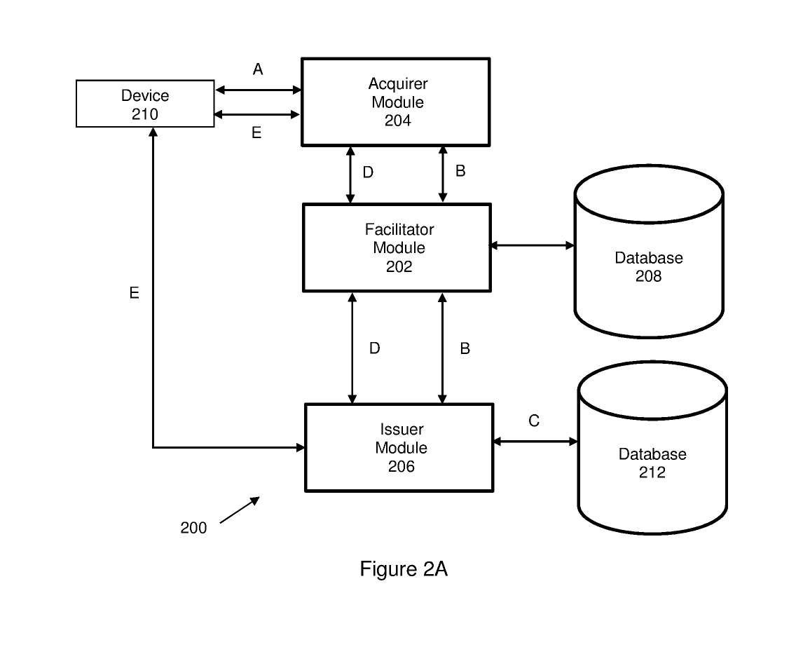

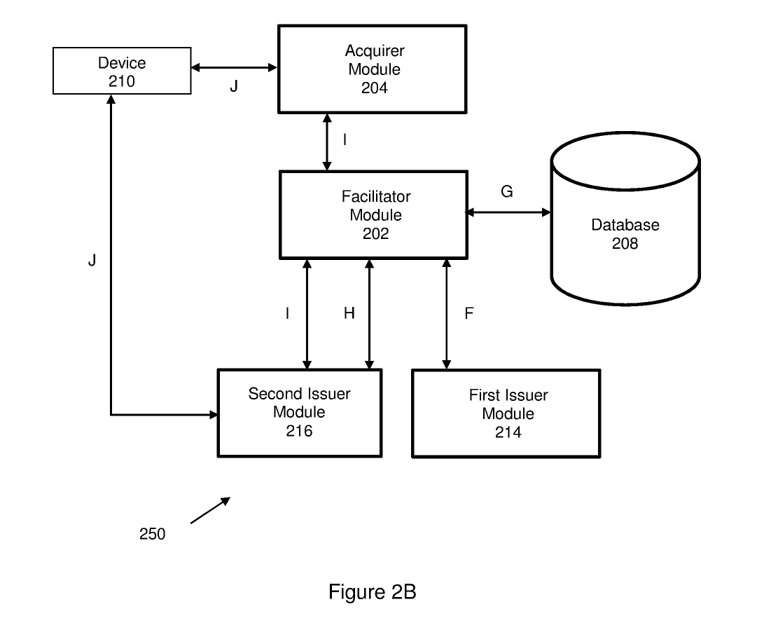

FIG. 2A shows a schematic diagram illustrating the flow of information in a system 200 for automated switching of payment devices with an identical issuer in the payment transaction, according to an example embodiment. The system 200 comprises a facilitator module 202, an acquirer module 204, an issuer module 206, a device 210 and databases 208, 212. The facilitator module 202 is in communication with the acquirer module 204, the issuer module 206 and the database 208. The acquirer module 204 is in communication with the device 210 and the issuer module 206 is in communication with database 212. The acquirer module 204 is typically associated with an acquirer who may be an entity (e.g., a company or organization) which provides and administers an account (e.g., a financial bank account) of the merchant. Examples of the acquirer include a bank and/or other financial institution. The acquirer module 204 is configured to receive a payment transaction request comprising primary card data of a primary card with which to make payment for a purchase of a product or service.

It can be appreciated that other types of non-card payment devices can be used. For example, contactless payment devices, such as payment-enabled wearable devices, i.e., rings, bracelets and other jewelry, are not cards. Other non-card payment devices may include virtual wallets, such as Apple Pay™ and Samsung Pay™. Therefore, the acquirer module 204 may be configured to receive a payment transaction request from a primary payment device with which to make payment for the purchase of the product or service. The term “card” (or “cards”) recited hereinafter may thus be interchangeably referred to as “payment devices”.

The facilitator module 202 may be operated by a payment network. For example, the facilitator module 202 may be, or may form part of, the Banknet™ network of Mastercard® Incorporated. The payment network may be an entity (e.g., a company or organization) that operates to process transactions, clear and settle funds for payments between two other entities (e.g. two banks). The facilitator module 202 routes information between the acquirer module 204 and the issuer module 206. The facilitator module 202 is configured to retrieve, from the database 208, identification data for a secondary payment device which is associated with the primary payment device in response to a payment status message from an issuer of the primary payment device which is indicative of a partial approval or a decline of a payment transaction request for the primary payment device. The facilitator module 202 is also configured to generate a secondary payment instruction comprising the identification data of the secondary payment device and an amount or a remaining amount of the payment transaction; and transmit the payment instruction to an issuer of the secondary payment device.

The issuer module 206 is generally associated with a payment device (or card) issuer, i.e., the issuer of the primary payment device used in the payment transaction request. The payment device issuer may be an entity (e.g., a company or organization) that issues (e.g., establishes, manages, administers) a card account (e.g., a credit card account, a stored value card, or a debit card account linked to a bank account). As described above, the facilitator module 202, the acquirer module 204 and the issuer module 206 may include one or more computing devices that are used to support the system 200 operating in the automated switching of payment devices in the payment transaction.

A user may wish to purchase a product or a service from a merchant after surfing on the internet, looking at a printed advertisement or during shopping at a mall. The user subsequently enters, in a handheld device, his primary card details for payment together with the product/service he wishes to purchase. In an online transaction, the user may surf the internet and choose the product or service at the merchant's website. The user then proceeds to purchase the product/service through the merchant's website or using a mobile application on his mobile phone. The device 210 may therefore be, for example, a mobile terminal, such as a laptop computer, smartphone, smartwatch or a tablet with an advanced mobile operating system, such as Windows of Microsoft®, iOS of Apple® Inc. or Android of Google® Inc. The operating system may host the mobile application, where the mobile application includes a card account management application which the user uses to initiate a payment transaction request. Alternatively, the user may be at a physical store of the merchant and wish to purchase the product or service. The device 210 may therefore be a point-of-sale (POS) terminal at the merchant's store where the payment transaction request is initiated.

At step A, the payment transaction request is received at the acquirer module 204 for the purchase of the product/service. The payment transaction request may identify the primary payment device to be used for payment and may include the product/service data, an issuer identifier and user account data. The user account data may include the user's primary payment device details, such as the user's name, a token identifier, a primary card number or a card verification value (CVV) of the primary payment device. The product/service data may include a product/service description, a product/service price and the merchant associated with the product/service. At step B, the acquirer module 204 transmits the payment transaction request, through the facilitator module 202, to the issuer module 206.

For example, the user may wish to purchase a drill set worth $300 at a hardware store after browsing through the products in the store. During checkout, the user swipes his primary card at the POS terminal of the merchant. The payment transaction request thus includes the card number (e.g., 12345), the description of the drill set and the cost of $300 for the drill set. In another embodiment, the user may wish to purchase the $300 drill set after looking at a merchant's website and proceeds to check out the drill set at the merchant's website. The merchant's acquirer sends the payment request to an issuer ABC of the primary card 12345.

At step C, after receiving the payment transaction request, the issuer module 206 determines a sufficiency of funds in the user's primary card account to settle the payment request. At this step, the issuer module 206 may retrieve identification data associated with the primary payment device from the database 212. When the issuer module 206 identifies that the user has insufficient funds in his primary payment device to settle the payment of the payment transaction, the issuer module 206 subsequently transmits a payment status message to decline the payment transaction request. If the issuer of the primary payment device and the issuer of the secondary payment device are identical, the issuer module 206 may further retrieve, from the database 212, identification data for payment of the payment transaction using a secondary payment device. The identification data may comprise user account data linked to the secondary payment device. The issuer module 206 then determines the sufficiency of funds in the secondary payment device and proceeds to deduct the funds to settle the payment transaction.

In another embodiment, the user may input an invalid Personal Identification Number (PIN) of the primary payment device when initiating the payment transaction request. The issuer module 206 retrieves identification data associated with the primary payment device and identifies that the PIN of the primary payment device is invalid. The issuer module 206 transmits the payment status message based on the invalidity of the PIN and declines the payment transaction. If the issuer of the primary payment device and the issuer of the secondary payment device are identical, the issuer module 206 may further retrieve, from the database 212, identification data for payment of the payment transaction using a secondary payment device. The identification data may comprise user account data linked to the secondary payment device. The issuer module 206 then transmits a request to the user for a PIN associated with the secondary payment device (not shown in FIG. 2A). Upon a successful verification of the PIN of the secondary payment device, the issuer module 206 proceeds to deduct the funds to settle the payment transaction.

At step D, the issuer module 206 transmits, through the facilitator module 202, a payment status indicating the successful payment of the payment transaction by the secondary payment device to the acquirer module 204. At step E, the acquirer module 204 transmits confirmation data to the merchant via the device 210, which may be a POS terminal of the merchant. The confirmation data may include payment confirmation for the payment transaction. If the device 210 is the user's mobile phone or laptop, the issuer module 206 may transmit confirmation data to the user to indicate the successful payment of the payment transaction by the secondary payment device. On the other hand, if the issuer module 206 determines that there are insufficient funds in the secondary payment device, the payment transaction request is unsuccessful and the payment transaction is declined.

Continuing from the above example, ABC is the issuer of the primary card 12345 and a secondary card 67890 of the user. The user uses his primary card 12345 to pay for the $300 drill set. ABC determines if the user's primary card account has sufficient balance to pay for the price of $300. If the user's primary card account indicates that he only has $250 left, ABC declines the transaction. ABC further determines, by retrieving identification data from its database, the presence of the secondary card 67890. As the issuer of the primary card and the issuer of the secondary card are identical, ABC proceeds to deduct $300 from the user's account of the secondary card 67890. Subsequently, ABC sends the user a message to inform him that $300 is deducted from his secondary card 67890.

In another embodiment, the user uses his primary card 12345 to pay for the $300 drill set but inputs an invalid PIN for primary card 12345. ABC determines that the PIN is invalid and declines the payment transaction. ABC further determines, by retrieving identification data from its database, the presence of the secondary card 67890. As the issuer of the primary card and the issuer of the secondary card are identical, ABC transmits a request to the user for the PIN of the secondary card 67890. After the user enters the correct PIN and ABC verifies that the PIN for secondary card 67890 is valid, ABC proceeds to deduct $300 from the user's account of the secondary card 67890. Subsequently, ABC sends the user a message to inform him that $300 is deducted from his secondary card 67890.

In an alternative embodiment, the issuer of the primary payment device and the issuer of the secondary payment device are not identical. FIG. 2B illustrates the flow of information in a system 250 for the automatic switching of payment devices when the issuer of the primary payment device and the issuer of the secondary payment device are not identical. In this case, and as shown at step F of FIG. 2B, the first issuer module 214 transmits the payment status message indicative of a decline of the payment transaction to the facilitator module 202. Subsequently at step G, the facilitator module 202 retrieves identification data from the database 208 in response to the payment status message from the first issuer module 214. The identification data may comprise a second issuer identifier associated with the issuer of the secondary payment device and user account data linked to the secondary payment device.

At step H, the facilitator module 202 transmits the payment transaction request to a second issuer module 216 based on the second issuer identifier. The second issuer module 216 receives the payment transaction request and determines if there are sufficient funds in the secondary payment device for payment. Alternatively, the second issuer module 216 may transmit a PIN request for the secondary payment device to the user if the PIN of the primary payment device is invalid. At step I, if there are sufficient funds in the user's account, or if the PIN associated with the secondary payment device is successfully verified, the second issuer module 216 transmits, through the facilitator module 202, a payment status indicating the successful payment of the payment transaction by the secondary payment device to the acquirer module 204. At step J, similar to step E of FIG. 2A, the acquirer module 204 transmits confirmation data to the merchant via the device 210 indicating successful payment for the payment transaction. If the device 210 is the user's mobile phone or laptop, the second issuer module 216 may transmit confirmation data to the user via the user's device to indicate the successful payment of the payment transaction by the secondary payment device (step J).

For example, ABC is the issuer of the primary card 12345 and XYZ is the issuer of the secondary card 67890 of the user. The user uses his primary card 12345 to pay for the $300 drill set. ABC determines if the user's primary card account has sufficient balance to pay for the price of $300. If the user's primary card account indicates that he only has $250 left, or the PIN for primary card 12345 is invalid, ABC declines the transaction and transmits the payment status message to the facilitator module 202. The facilitator module 202 determines from its database 208, that the secondary card 67890 is present and transmits the payment transaction request to XYZ. XYZ proceeds to deduct $300 from the user's account of the secondary card 67890. Alternatively, XYZ may transmit a PIN request for secondary card 67890 to the user if the PIN for primary card 12345 is invalid. If the PIN for secondary card 67890 is valid and successfully verified, XYZ proceeds to deduct $300 from the user's account of secondary card 67890. XYZ then sends the user a message to inform him that $300 is deducted from his secondary card 67890.

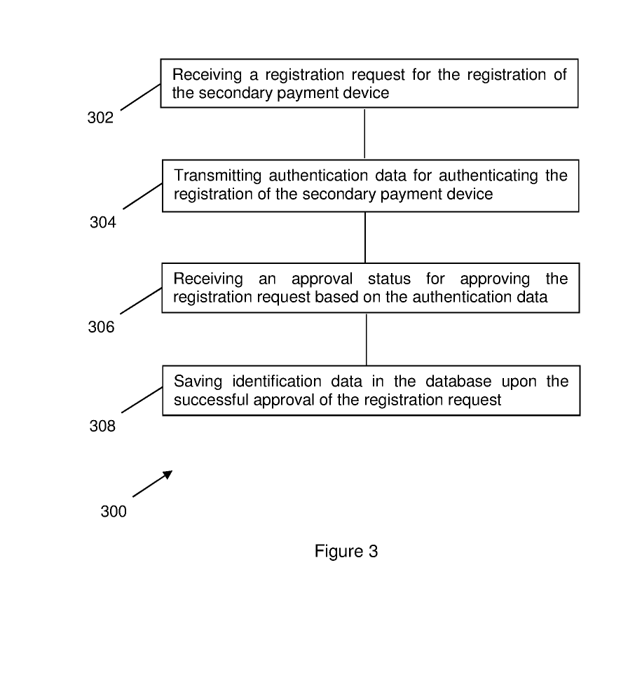

FIG. 3 shows a flow chart 300 illustrating a method for a one-time registration of a secondary payment device according to an example embodiment. At step 302, a registration request for the registration of the secondary payment device is received by an issuer module. At step 304, authentication data for authenticating the registration of the secondary payment device is transmitted by the issuer module. At step 306, an approval status for approving the registration request based on the authentication data is received by a facilitator module. At step 308, identification data is saved in the database by the facilitator module upon the successful approval of the registration request.

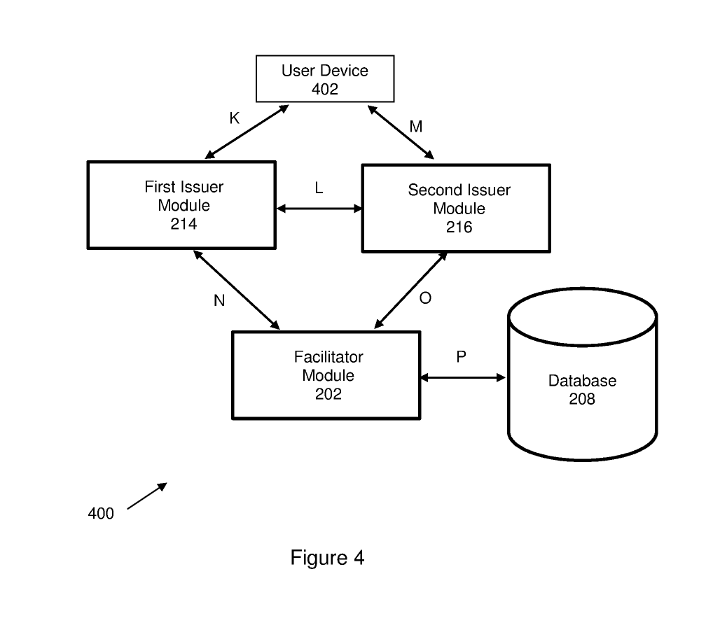

FIG. 4 shows a schematic diagram illustrating the flow of information in a system 400 for the one-time registration of the secondary payment device, according to an example embodiment. The one-time registration of the secondary payment device facilitates the automatic switching of payment devices from the primary payment device to the secondary payment device without the user submitting a manual request to switch the payment devices when there are insufficient funds in the primary payment device. The system 400 comprises a user device 402, a first issuer module 214, a second issuer module 216, a facilitator module 202 and a database 208 associated with the facilitator module 202. The facilitator module 202 is in communication with the first issuer module 214, the second issuer module 216 and the database 208. The first issuer module 214 and the second issuer module 216 are in communication with one another and the user device 402.

A user may wish to nominate a secondary payment device for a primary payment device before a payment transaction request is generated for a product/service he wishes to purchase. The user enters a nomination request, in the user device 402, by providing his primary payment device and the secondary payment device details. The user device 402 may therefore be, for example, a mobile terminal, such as a laptop computer, smartphone, smartwatch or a tablet with an advanced mobile operating system. The operating system may host the mobile application, where the mobile application includes an account management application which the user uses to submit his payment devices' details. Alternatively, the nomination request may be physically written on a form for submission.

At step K, the user device 402 transmits the nomination request to the first issuer module 214 that is associated with the primary payment device. The first issuer module 214 sends a one-time password (OTP) to the user, via the user device 402, for authentication of the primary payment device. The user authenticates and the first issuer module 214 updates the information on its database (not shown). At step L, the first issuer module 214 transmits to the second issuer module 216 of the secondary payment device. At step M, the second issuer module 216 sends an OTP to the user, via the user device 402, to authenticate the secondary payment device. The user authenticates and the second issuer module 216 updates the information for the secondary payment device on its database (not shown).

At step N, the first issuer module 214 transmits information of the primary payment device to the facilitator module 202 upon the user's authentication of the primary payment device. At step O, the second issuer module 216 transmits information of the secondary payment device to the facilitator module 202 upon the user's authentication of the secondary payment device. At step P, the facilitator module 202 stores the information of both the primary payment device and the secondary payment device in the database 208.

In another embodiment, the first issuer module 214 and the second issuer module 216 are identical. In this case, there is only a single issuer module and it stores both the primary payment device and secondary payment device details in its database (not shown). In other words, the first issuer module 214 and the second issuer module 216 are the same. The single issuer module then sends the primary payment device and secondary payment device details to the facilitator module 202 to be saved into database 208.

In an example, a user wishes to nominate a secondary card 67890 issued by XYZ for a primary card 12345 that is issued by ABC. He sends the nomination request to ABC and receives an OTP from ABC for authenticating his request for primary card 12345. After he authenticates, ABC saves the data and sends XYZ the nomination request. At the same time, ABC sends primary card data to a facilitator FGH. XYZ subsequently sends another OTP for authentication of his secondary card 67890. After the user authenticates, XYZ sends the secondary card data to FGH and FGH saves both cards 12345 and 67890 into its database.

In certain cases, there are funds available in the primary payment device and the secondary payment device but the financial transaction may be declined if the funds in either payment device are not sufficient for full payment. For example, a user wishes to purchase a $300 drill set but his primary payment device has a balance of $250 while his secondary payment device has a balance of $150. The financial transaction may be declined as the funds in the primary payment device alone and the secondary payment device alone are insufficient for full payment of $300. However, the total funds in both cards, i.e. $450, are sufficient to pay for the drill. Therefore, a partial approval of a payment transaction request may be advantageous in this case.

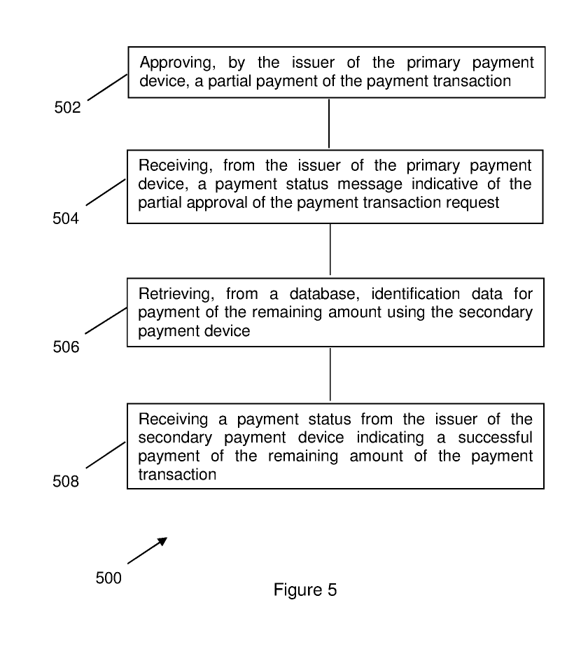

FIG. 5 shows a flow chart 500 illustrating a method for a partial approval of a payment transaction request according to an example embodiment. At step 502, an issuer of the primary payment device approves a partial payment of the payment transaction. At step 504, the facilitator receives a payment status message indicative of the partial approval of the payment transaction request by the issuer. At step 506, the facilitator retrieves identification data from a database for payment of the remaining amount using the secondary payment device. At step 508, the facilitator receives a payment status from the issuer of the secondary payment device indicating a successful payment of the remaining amount of the payment transaction.

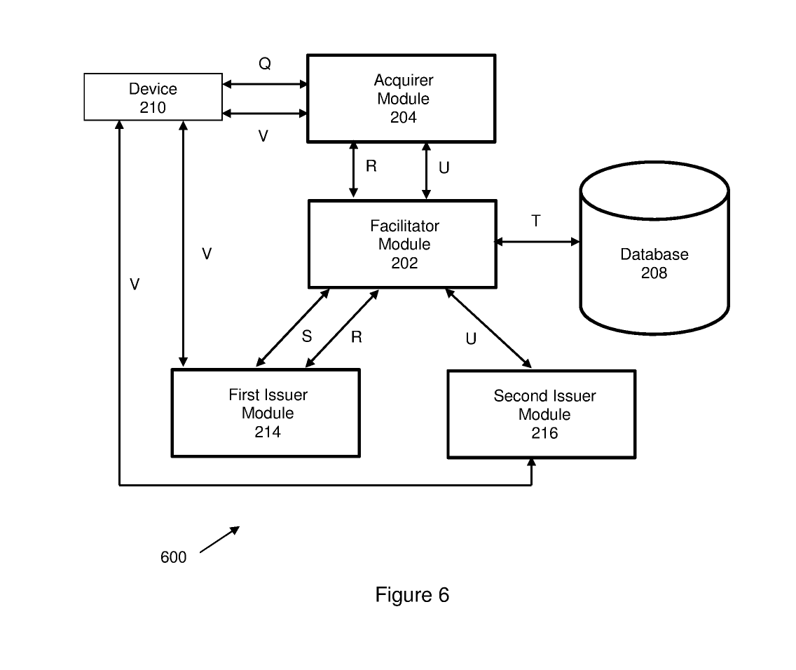

FIG. 6 shows a schematic diagram illustrating the flow of information in a system 600 for the partial approval of the payment transaction request, according to an example embodiment. The system 600 comprises a device 210, an acquirer module 204, a first issuer module 214, a second issuer module 216, a facilitator module 202 and a database 208 associated with the facilitator module 202. At step Q, the payment transaction request is received at the acquirer module 204 for the purchase of the product/service. At step R, the acquirer module 204 transmits the payment transaction request, through the facilitator module 202, to the first issuer module 214 for partial payment. The first issuer module 214 determines there are funds in the primary payment device but are insufficient for full payment of the payment transaction. The first issuer module 214 proceeds to deduct the total available funds from the primary payment device and approves the partial payment. At step S, the first issuer module 214 transmits a payment status message indicative of a partial approval of the payment transaction request to the facilitator module 202.

At step T, the facilitator module 202 retrieves identification data associated with a secondary payment device associated with the primary payment device from the database 208. The facilitator module 202 then generates a secondary payment instruction and a remaining amount of the payment transaction (not shown in FIG. 6). At step U, the facilitator module 202 transmits the secondary payment instruction to the second issuer module 216. The second issuer module 216 proceeds to deduct the remaining amount of the payment transaction from the secondary payment device. The second issuer module 216 subsequently transmits a payment status to the acquirer module 204, via the facilitator module 202, indicating a successful payment of the remaining amount of the payment transaction. At step V, similar to step E of FIG. 2A and step J of FIG. 2B, the acquirer module 204 transmits confirmation data to the merchant via the device 210 indicating successful payment of the payment transaction. If the device 210 is the user's mobile phone or laptop, the first issuer module 214 and the second issuer module 216 may transmit confirmation data to the user via the user's device to indicate the amount of funds deducted from each card for full payment of the payment transaction.

For example, a user wishes to purchase as drill set worth $300 from a merchant. The user proceeds to checkout using his primary card 12345 issued by ABC. A payment request of $300 is received by ABC and ABC determines there is only $200 in his primary card account. ABC proceeds to deduct $200 from the user's primary card account and sends confirmation of this deduction to the facilitator module 202. The facilitator module 202 then determines that the user has a secondary card 67890 issued by XYZ and sends the remaining amount, i.e., $100, to XYZ. XYZ determines that the secondary card 67890 has funds of $150 and proceeds to deduct $100 from the user's secondary card account. The facilitator module 202 sends the acquirer to confirm full payment of the drill set. The acquirer then sends confirmation data confirming the settlement of the payment of the drill set. ABC and XYZ send information to the user that $200 and $100 have been deducted from his primary card and his secondary card respectively.

In another embodiment, the issuer of the primary payment device and the issuer of the secondary payment device are identical. In this case, there is only a single issuer module and it authenticates and stores both the primary payment device and secondary payment device details in its database (not shown). In other words, the first issuer module 214 and the second issuer module 216 are the same. The single issuer module then sends the primary payment device and secondary payment device details to the facilitator module 202 to be saved into database 208.

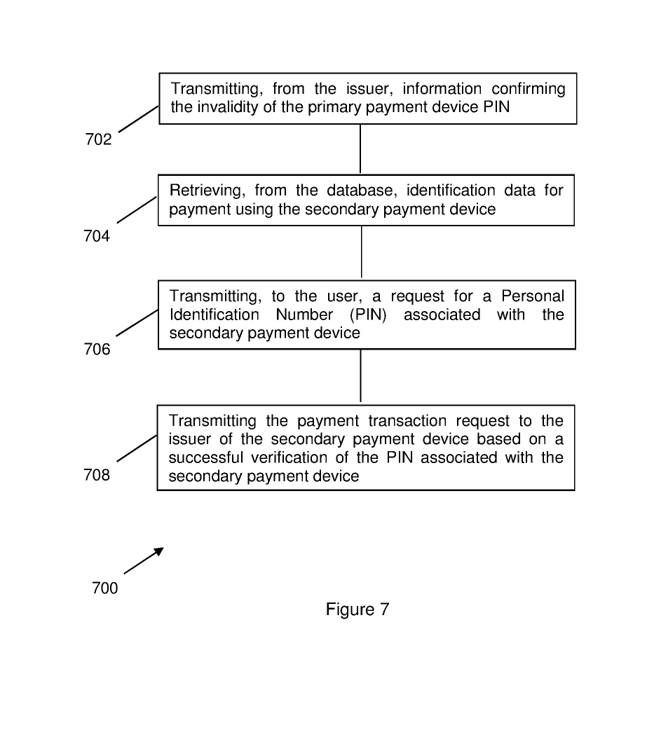

FIG. 7 shows a flow chart 700 illustrating a method for approval of a payment transaction request for an invalid Personal Identification Number (PIN) of a primary payment device according to an example embodiment. At step 702, an issuer of the primary payment device transmits information confirming the invalidity of the primary payment device PIN. At step 704, identification data is retrieved from the database for payment using the secondary payment device. At step 706, a request is transmitted to the user for a Personal Identification Number (PIN) associated with the secondary payment device. At step 708, the payment transaction request is transmitted to the issuer associated with the secondary payment device based on a successful verification of the PIN associated with the secondary payment device.

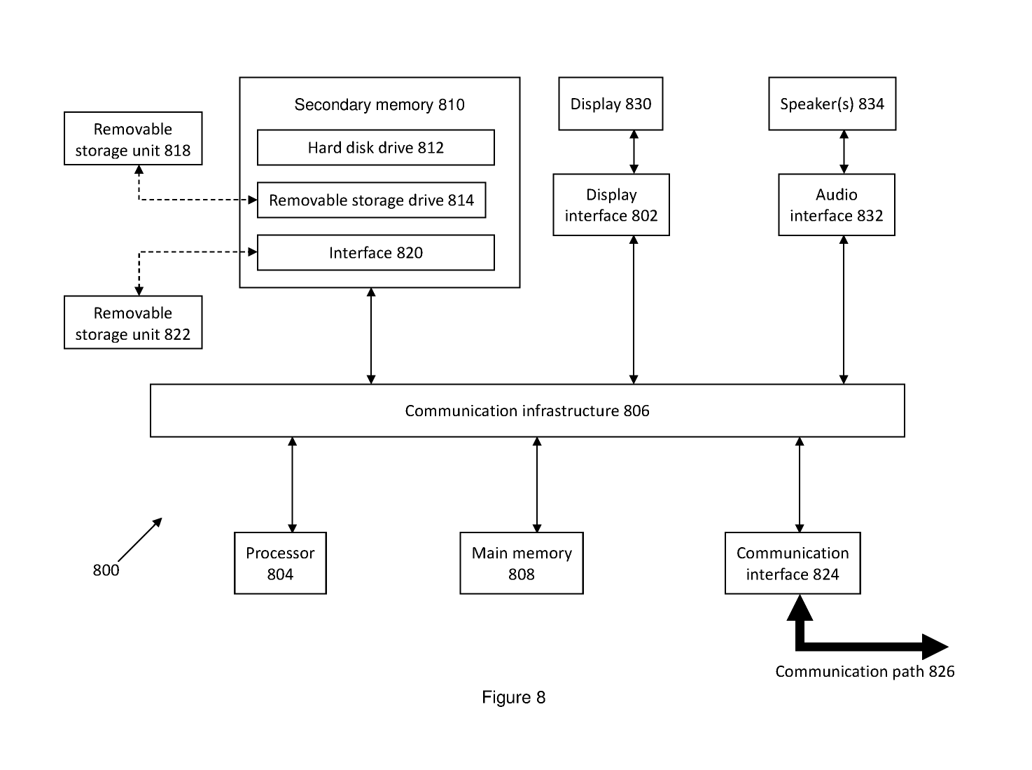

As described above, use of the term “module” herein may be understood to mean a single computing device or a plurality of interconnected computing devices which operate together to perform a particular function. An exemplary computing device which may be operated as a module is described below with reference to FIG. 8.

FIG. 8 shows a schematic diagram of a computer device or computer system 800 suitable for realizing the facilitator module 202, the acquirer module 204, the issuer module 206, the first issuer module 214 and/or the second issuer module 216, according to an example embodiment. The following description of the computing device 800 is provided by way of example only and is not intended to be limiting.

As shown in FIG. 8, the example computing device 800 includes a processor 804 for executing software routines. Although a single processor is shown for the sake of clarity, the computing device 800 may also include a multi-processor system. The processor 804 is connected to a communication infrastructure 806 for communication with other components of the computing device 800. The communication infrastructure 806 may include, for example, a communications bus, cross-bar, or network.

The computing device 800 further includes a main memory 808, such as a random access memory (RAM), and a secondary memory 810. The secondary memory 810 may include, for example, a hard disk drive 812, which may be a hard disk drive, a solid state drive or a hybrid drive and/or a removable storage drive 814, which may include a magnetic tape drive, an optical disk drive, a solid state storage drive (such as a USB flash drive, a flash memory device, a solid state drive or a memory card), or the like. The removable storage drive 814 reads from and/or writes to a removable storage unit 818 in a well-known manner. The removable storage unit 818 may include magnetic tape, optical disk, non-volatile memory storage medium, or the like, which is read by and written to by removable storage drive 814. As will be appreciated by persons skilled in the relevant art(s), the removable storage unit 818 includes a computer readable storage medium having stored therein computer executable program code instructions and/or data.

In an alternative implementation, the secondary memory 810 may additionally or alternatively include other similar means for allowing computer programs or other instructions to be loaded into the computing device 800. Such means can include, for example, a removable storage unit 822 and an interface 820. Examples of a removable storage unit 822 and interface 820 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 822 and interfaces 820 which allow software and data to be transferred from the removable storage unit 822 to the computer system 800.

The computing device 800 also includes at least one communication interface 824. The communication interface 824 allows software and data to be transferred between computing device 800 and external devices via a communication path 826. In various embodiments, the communication interface 824 permits data to be transferred between the computing device 800 and a data communication network, such as a public data or private data communication network. The communication interface 824 may be used to exchange data between different computing devices 800 which such computing devices 800 form part an interconnected computer network. Examples of a communication interface 824 can include a modem, a network interface (such as an Ethernet card), a communication port (such as a serial, parallel, printer, GPIB, IEEE 1394, RJ45, USB), an antenna with associated circuitry, and the like. The communication interface 824 may be wired or may be wireless. Software and data transferred via the communication interface 824 are in the form of signals which can be electronic, electromagnetic, optical or other signals capable of being received by communication interface 824. These signals are provided to the communication interface via the communication path 826.

As shown in FIG. 8, the computing device 800 further includes a display interface 802 which performs operations for rendering images to an associated display 830 and an audio interface 832 for performing operations for playing audio content via associated speaker(s) 834.

As used herein, the term “computer program product” may refer, in part, to removable storage unit 818, removable storage unit 822, a hard disk installed in hard disk drive 812, or a carrier wave carrying software over communication path 826 (wireless link or cable) to communication interface 824. Computer readable storage media refers to any non-transitory tangible storage medium that provides recorded instructions and/or data to the computing device 800 for execution and/or processing. Examples of such storage media include magnetic tape, CD-ROM, DVD, Blu-Ray™ Disc, a hard disk drive, a ROM or integrated circuit, a solid state drive (such as a USB flash drive, a flash memory device, a solid state drive or a memory card), a hybrid drive, a magneto-optical disk, or a computer readable card, such as a PCMCIA card, and the like, whether or not such devices are internal or external of the computing device 800. Examples of transitory or non-tangible computer readable transmission media that may also participate in the provision of software, application programs, instructions and/or data to the computing device 800 include radio or infra-red transmission channels as well as a network connection to another computer or networked device, and the Internet or Intranets including e-mail transmissions and information recorded on Websites, and the like.

The computer programs (also called computer program code) are stored in main memory 808 and/or secondary memory 810. Computer programs can also be received via the communication interface 824. Such computer programs, when executed, enable the computing device 800 to perform one or more features of embodiments discussed herein. In various embodiments, the computer programs, when executed, enable the processor 804 to perform features of the above-described embodiments. Accordingly, such computer programs represent controllers of the computer system 800.

Software may be stored in a computer program product and loaded into the computing device 800 using the removable storage drive 814, the hard disk drive 812, or the interface 820. Alternatively, the computer program product may be downloaded to the computer system 800 over the communications path 826. The software, when executed by the processor 804, causes the computing device 800 to perform functions of embodiments described herein.

It is to be understood that the embodiment of FIG. 8 is presented merely by way of example. Therefore, in some embodiments one or more features of the computing device 800 may be omitted. Also, in some embodiments, one or more features of the computing device 800 may be combined together. Additionally, in some embodiments, one or more features of the computing device 800 may be split into one or more component parts.

The automated switching of payment devices in a payment transaction as described herein may result in the consumer being able to purchase the product/service he wishes even though he is unaware that there are insufficient funds in his primary payment device account. The merchant may also be able to sell his product/service to the consumer. Further, the consumer may have forgotten the PIN or may have input the wrong PIN for his primary payment device and the consumer may not be able to continue his purchase if the transaction is declined. Advantageously, this allows consumers access to one or more payment device accounts while using a single payment device and grants the consumer flexibility in using different payment device accounts for various types of transactions with a single payment device.

In addition, the consumer may be saved the trouble of bringing multiple payment devices (e.g., cards) in his wallet. Accordingly, consumers would be able to use payment device accounts associated with payment devices that are not presently on hand, or use payment devices that have reached a credit limit, or have zero debit balance. Consumers may also use other payment device accounts when they have forgotten the PIN of the primary payment device. Partial payment of the payment transaction from two different payment devices may also avoid the rejection of the payment transaction request even when the combined funds of the two different payment devices are sufficient for full payment of the payment transaction.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for automated switching of payment devices during a payment transaction, the system including a facilitator module comprising:
at least one processor; and
at least one memory in communication with the at least one processor and including computer program code;
the at least one memory and the computer program code configured to, with the at least one processor, cause the facilitator module at least to:
in response to a payment status message from an issuer of a primary payment device which is indicative of a partial approval or a decline of a payment transaction request for the primary payment device, retrieve, from a database, identification data for a secondary payment device which is associated with the primary payment device;
generate a secondary payment instruction comprising the identification data of the secondary payment device, and an amount or a remaining amount of the payment transaction; and
transmit the secondary payment instruction to an issuer of the secondary payment device.

2. The system of claim 1, wherein the payment status message comprises data which is indicative of insufficient funds in the primary payment device.

3. The system of claim 1, wherein the issuer of the primary payment device is the same as the issuer of the secondary payment device.

4. The system of claim 1, wherein the facilitator module is further caused to transmit the payment transaction request to the issuer of the secondary payment device for payment of the amount or the remaining amount of the payment transaction.

5. The system of claim 1, wherein the facilitator module is further caused to:
receive a registration request for a registration of the secondary payment device;
transmit authentication data for authenticating the registration of the secondary payment device;
receive an approval status for approving the registration request based on the authentication data; and
save identification data in the database upon the successful approval of the registration request.

6. The system of claim 1, wherein the facilitator module is further caused to:
receive a payment status from the issuer of the secondary payment device confirming payment for the payment transaction by the secondary payment device;
transmit confirmation data to a merchant associated with the payment transaction request, the confirmation data comprising payment confirmation for the payment transaction; and
transmit confirmation data to a user to indicate the successful payment of the payment transaction by the secondary payment device.

7. The system of claim 1, wherein the facilitator module is further caused to:
receive confirmation of an invalid Personal Identification Number (PIN) of the primary payment device;
transmit, from the issuer, information confirming the invalidity of the primary payment device PIN;
retrieve, from the database, identification data for payment using the secondary payment device;
transmit, to the user, a request for a Personal Identification Number (PIN) associated with the secondary payment device; and
transmit the payment transaction request to the issuer of the secondary payment device based on a successful verification of the PIN associated with the secondary payment device.

8. A method for automated switching of payment devices during a payment transaction, the method comprising:
in response to a payment status message from an issuer of a primary payment device which is indicative of a partial approval or a decline of a payment transaction request for the primary payment device, retrieving, from a database, identification data for a secondary payment device which is associated with the primary payment device;
generating a secondary payment instruction comprising the identification data of the secondary payment device and an amount or a remaining amount of the payment transaction; and
transmitting the payment instruction to an issuer of the secondary payment device.

9. The method of claim 8, further comprising performing a one-time registration of the secondary payment device before receiving the payment transaction request.

10. The method of claim 9, wherein performing the one-time registration of the secondary payment device comprises:
receiving a registration request for a registration of the secondary payment device;
transmitting authentication data for authenticating the registration of the secondary payment device;
receiving an approval status for approving the registration request based on the authentication data; and
saving identification data in the database upon the successful approval of the registration request.

11. The method of claim 8, wherein the payment status message comprises data which is indicative of insufficient funds in the primary payment device.

12. The method of claim 8, wherein the issuer of the primary payment device is the same as the issuer of the secondary payment device.

13. The method of claim 8, further comprising:
receiving a payment status from the issuer of the secondary payment device confirming payment for the payment transaction by the secondary payment device; and
transmitting confirmation data to a merchant associated with the payment transaction request, the confirmation data comprising payment confirmation for the payment transaction.

14. The method of claim 13, wherein the confirmation data is transmitted to the merchant on the condition that the payment status comprises a successful payment of the payment transaction by the secondary payment device.

15. The method of claim 8, further comprising transmitting confirmation data to a user to indicate the successful payment of the payment transaction by the secondary payment device.

16. The method of claim 8, further comprising receiving, from the issuer of the primary payment device, the partial approval of the payment transaction request.

17. The method of claim 16, further comprising:
approving, by the issuer of the primary payment device, a partial payment of the payment transaction;
receiving, from the issuer of the primary payment device, a payment status message indicative of the partial approval of the payment transaction request;
retrieving, from a database, identification data for payment of the remaining amount using the secondary payment device; and
receiving a payment status from the issuer of the secondary payment device indicating a successful payment of the remaining amount of the payment transaction.

18. The method of claim 8, further comprising receiving, from the issuer of the primary payment device, the decline of the payment transaction request for the primary payment device;
wherein receiving the decline of the payment transaction request for the primary payment device includes receiving confirmation of an invalid Personal Identification Number (PIN) of the primary payment device.

19. The method of claim 18, wherein receiving confirmation of the invalid PIN of the primary payment device comprises:
transmitting, from the issuer, information confirming the invalidity of the primary payment device PIN;
retrieving, from the database, identification data for payment using the secondary payment device;
transmitting, to the user, a request for a Personal Identification Number (PIN) associated with the secondary payment device; and
transmitting the payment transaction request to the issuer of the secondary payment device based on a successful verification of the PIN associated with the secondary payment device.
